(19) United States
(12) Patent Application Publication
(10) Pub. No.: US 2006/0162128 A1
(43) Pub. Date: Jul. 27, 2006

(54) Removable gripping handle for grilling tools

(76) Inventor: Peter F. Prip, Cranston, RI (US)

Correspondence Address: CRISTINA M. OFFENBERG, 494 BROADWAY, NEWPORT, RI, 02840, US

(21) Appl. No.: 11/038,154

(22) Filed: Jan. 21, 2005

(51) Int. Cl. B25G 3/32

(52) U.S. Cl. 16/422

(57) ABSTRACT

A removable gripping handle adaptable for use with grilling tools comprised of elongated tong arms with convex ball connectors projecting from the bottom unconnected end of each said tong arm. The convex ball connectors are shaped to find and seat within concave socket connectors on the mounting bracket of a grilling tool so as to fix the handle relative to the tool so the tool may be place on or removed from the grill.

This invention relates to equipment or tools used for grilling or barbecuing food, and more particularly to a removable gripping handle for lifting and maneuvering a grilling or cooking tool during the grilling process.

### BACKGROUND OF THE INVENTION

Persons who cook food on a barbecue grill often use a variety of grilling tools to hold the food items in place or to maneuver the food items during the grilling process. This is done so that the cook can grill small items without them falling through the grates and so the food can be moved onto and off of the grill as well as to flip the food during cooking without burning the cook.

Some problems often encountered with grilling tools are inability to close the cover or inability to turn the food over on the grill. In the case of tools with fixed handles having compartments that hold or contain food, there is an inability to close the top lip or cover of the barbecue cooker. Having an unsealed closure of the grill, makes it difficult to stop flare ups, slow cook food or smoke food. Consequently, only grilling tools without handles could be used when it becomes necessary to close the barbecue cover. Tools without handles cannot be used to turn the food over on the grill top and a user must use another tool such as a spatula to flip the food. Although there are some grilling tools on the market with removable handles, they are proven to be awkward and difficult to use because they limit the user to incremental or fixed positions. The ideal use is fluid use of a tool and users would prefer versatility when around a hot grill. Shish ka bob skewers require the user to lean in over a hot fire to grill. Skewers that are contained on a rack still require the user to lean in over the fire to turn them and having a tool which is adaptable to turning the skewers and also removing the handle to close the lid is the ideal tool.

It is therefore one object of the present invention to provide a removable gripping handle for barbecue grilling tools that is easy to use and allows the top lid of the barbecue grill to be closed during cooking.

Another object of the present invention is to provide a removable gripping handle that is interchangeable with several grilling tools.

Still another object of the present invention is to provide a removable gripping handle for grilling tools that engages the grilling tool quickly and at any angle before locking into position.

Still another object of the present invention is to provide a removable gripping handle for grilling tools that has ball and socket connections or convex/concave connectors that allow for ease of use.

Yet another object of the present invention is to provide a removable gripping handle for grilling tools in which the connection parts easily find and align themselves because of a combination of shape and leveraging device.

Yet another object of the present invention is to provide a removable gripping handle for grilling tools that has a nib extending from the connection ends that allows the user to leverage the removable gripping handle to grilling tool or to leverage the grilling tool to the gripping handle.

Still another object of the present invention is to provide a removable gripping handle for grilling tools or the like that is easy to attach or remove from the grilling tools because of a leveraging or centering nib.

### SUMMARY OF THE INVENTION

In accordance with the principles of the invention a removable gripping handle for grilling tools comprised of two elongated tong arms connected together by an integral flexible portion that is “U” shaped at one end and having convex ball connectors at a bottom unconnected end of each tong arm. The convex connectors have a raised or male pattern, such as an “X” shape, on an exterior surface which corresponds to a concave receiving finding having an aperture or female pattern on an interior surface located on a bracket of the grilling tool. The removable gripping handle is made of stiff metal material formed into a pair of tong arms allowing for compression spring back due to the “U” shaped flexible portion. Each bottom end of a tong arm terminates with a convex connector that is shaped as a half ball. A permanent bracket is attached to a grilling tool that has two space apart flanges. Fixed along the outer surface of each tong arm by a suitable means such as an adhesive or rivets is an elongated gripping member made of material that is sufficient for gripping such as wood, rubber, plastic or the like. The gripping members are orientated for a user to easily grip the gripping handle in one hand and to allow the continuous application of sufficient force to move the tong arms together and to also turn the grilling tool over on the grill or to remove the grilling tool from the grill.

By fully compressing the tong arms of the removable gripping handle at a location between their bottom ends and the “U” shape, the convex connectors of the tong arms are moved close together and this enables the male raised pattern to be positioned within the spaced apart flanges and the concave receiving findings on the grilling tool. The user does not have to perfectly align the corresponding patterns when attaching the gripping handle to the tool which at times can prove to be difficult. Instead, when the pressure on the gripping handle is released, the combination of the outward pressure of the tong arms and the convex/concave nature of the ball and socket connectors assists the user to maneuver the gripping handle downward or upward until the two patterns are in exact alignment. The convex connection ends will nest or seat in the concave receiving findings and the male raised pattern locks into the female aperture patterns thereby attaching the gripping handle in position for use. Once the removable gripping handle is in the attached position as just described, the removable gripping handle can be used to lift or move the grilling tool onto the grill, to flip the grilling tool over while on the grill and/or to remove the grilling tool from the grill when cooking is completed.

The female aperture pattern can be positioned or orientated to provide different receiving positions for seating the male raised pattern on the convex connectors of the tong arms into the receiving findings of the tool thereby providing different angular positions for the removable gripping handle relative to the grilling tool. The most common position is with the removable gripping handle level relative to the tool. A second typical position is with the removable gripping handle at an up angle in relation to the grilling tool. The third type position is with the removable gripping handle perpendicular relative to the grilling tool. The receiving finding of the grilling tool is formed with the particular aperture in a particular orientation. The orientation depends on the particular tool and how it is used during cooking or grilling. For example, if the grilling tool is a wok, then the relative position of the removable gripping handle to the grilling tool may be upwards so the user can shake the wok on the grill. If the grilling tool is a shish ka bob attachment, then the removable gripping handle will be level in relation to the grilling tool for ease of flipping the grilling tool over on the grill.

To increase the ability of the user to engage the corresponding convex connectors with a raised pattern to the concave receiving findings with an aperture pattern, the center of the convex connector is mounted with a leveraging or guiding nib protruding outwardly. As the guiding nib protrudes from the convex connector, the nib is the first part to come into contact with the interior wall of the concave receiving guiding. As the compressed pressure of the tong arms is released, the nib slides down the concave wall of the receiving finding to the center of the receiving finding and into a corresponding aperture in the center of the receiving finding. The nib holds the alignment needed until the positive and negative patterns are leveraged into position and locked into one another. The nib therefore allows the user to bring in the removable gripping handle at any angle convenient to the user and slide the nib into the receiving finding then lift the tool slightly off the grill or table top until the corresponding male and female patterns nest or seat themselves and thereby lock the gripping handle into position for use.

In the drawings, the pattern shown is an “X” pattern. Any corresponding pattern on the convex connectors and the concave receiving findings can be used. The best mode has been found to be the “X”; however protruding dots, “+” sign, half moon, or star, or any other design or shape will provide similar results. Additionally, the specification and drawings describe and show the removable gripping handle in use with grilling tools, however, this removable gripping handle is novel in its means of connecting and locking the handle to the bracket. This removable gripping handle may be used in any application where a permanent handle is typically used but a user has a need or desire for the handle to be removed such as a wagon, pots and pans, children's toys, or other “handled” objects.

Other objects, advantages and features of the invention will become apparent from the following detailed description of one embodiment thereof, taken in conjunction with the accompanying drawings.

### BRIEF DESCRIPTION OF THE DRAWING

FIG. 1 is a view of full view of the removable gripping handle having a shish ka bob grilling tool attached.

FIG. 2 is a side view of the removable gripping handle in both the compressed and uncompressed stages showing the elongated tong arms and convex connectors.

FIG. 3 is an enlarged view of the convex connector showing the raised “X” pattern and as fitted into the concave receiving finding.

FIG. 4 is an enlarged view showing the convex connector with the raised “X” pattern locked with the aperture “X” pattern in the concave receiving finding.

FIG. 5 is an enlarged side view of the nib leveraging feature located in the center of the “X” pattern.

### DETAILED DESCRIPTION OF EMBODIMENT

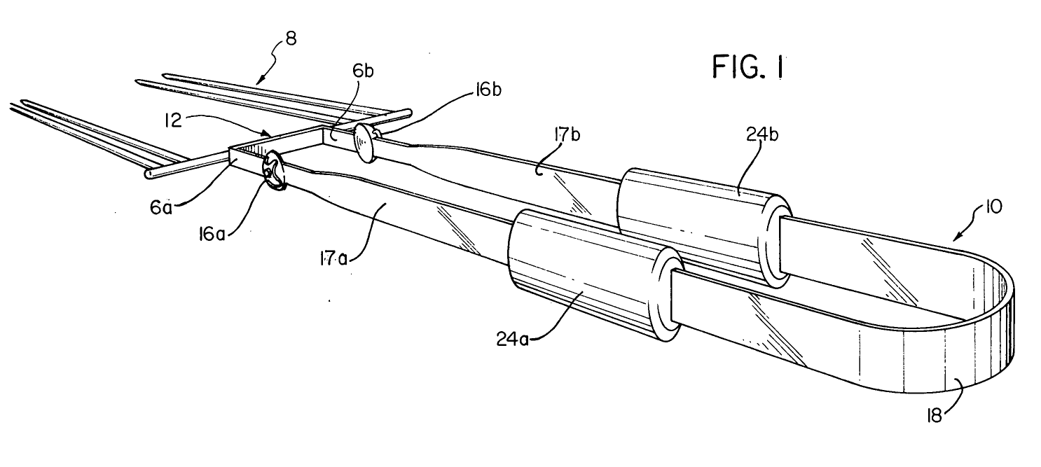

With reference to the drawing, FIG. 1 shows a typical grilling tool 8, a shish ka bob, which is used with foods that are cooked or grilled, usually over live coals or gas fire within a barbecue cooker having a lid or cover. The grilling tool 8 has a mounting bracket 12 for receiving a removable gripping handle 10. The mounting bracket 12 is securely mounted to the grilling tool 8 and extends outwardly from the grilling tool 8. The mounting bracket 12 is shown having two spaced apart and parallel flange members 6a and 6b each fitted with a receiving finding or concave socket connector 16a and 16b. The removable gripping handle 10 is constructed from a single piece of stiff metal material which is bent in a U-shaped configuration. Thus, the removable gripping handle has a pair of elongated tong arms 17a and 17b of uniform length which are integral with a flexible connecting portion 18 at the outer end of the handle 10. Fixed along the outer surface of each tong arm 17a and 17b, by a suitable means such as an adhesive or rivets, are elongated gripping members 24a and 24b. The gripping members 24a and 24b are orientated for a user to easily grip the gripping handle 10 in one hand and to apply continuous sufficient force to move the tong arms 17a and 17b together and to also turn the grilling tool over on the grill or to remove the grilling tool from the grill.

In this view, the removable gripping handle 10 is shown to be attached in the level position. A user of the grilling tool 8 can maneuver the removable gripping handle 10 to easily connect and disengage the gripping handle 10 from the grilling tool 8. A user can manipulate the removable gripping handle 10 with one hand easily to attach the removable gripping handle 10 to and remove the removable gripping handle 10 from the mounting bracket 12. Obviously, the same removable gripping handle 10 can be used to move or manipulate several grilling tools on one grill or several grills as well as other devices that are provided with the same mounting bracket 12.

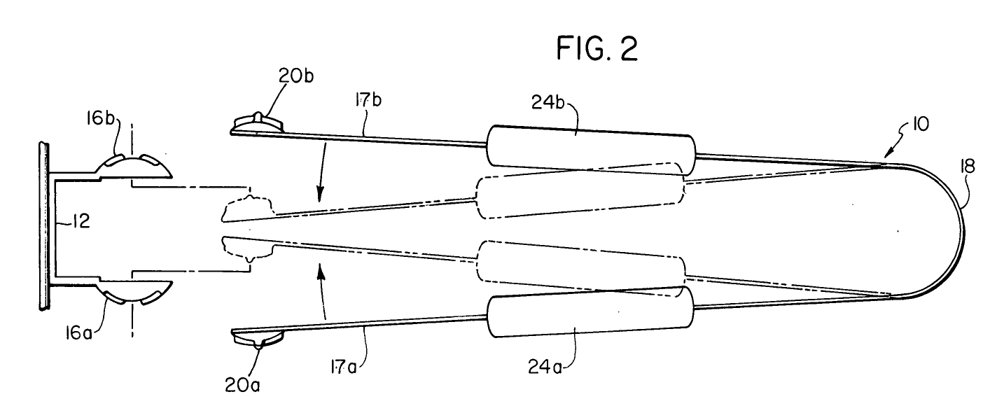

FIG. 2, shows a side view of the removable gripping handle 10 in both the uncompressed and compressed stage of use. At the bottom end of each tong arm 17a and 17b are convex ball connectors 20a and 20b. In the unrestrained configuration, the flexible connecting portion 18 of the removable gripping handle 10, normally leaves the tong arms 17a and 17b spaced apart. When the tong arms 17a and 17b are squeezed or compressed together by putting pressure on the connecting portion 18, the convex ball connectors 20a and 20b of the tong arms 17a and 17b are positioned closer together to fit just inside the concave socket connectors 16a and 16b. A raised pattern on the exterior side of the convex ball connectors 20a and 20b fit within a recessed female pattern on the interior side of the concave socket connectors 16a and 16b. Thus, when the pressure on the removable gripping handle 10 is released, the convex ball connectors 20a and 20b seat or nest within the concave socket connectors 16a and 16b. The male raised patterns are fitted and locked within the corresponding female recessed patterns. In this locked position, the removable gripping handle 10 can be used to place a grilling tool 8 on the grilling surface, flip a grilling tool 8 from a first side to a second side, or remove the grilling tool 8 from the grilling surface.

When the tong arms 17a and 17b are further compressed together so as to converge at their ends again, the convex ball connectors 20a and 20b of the tong arms 17a and 17b are moved closer together so that they can be disengaged and removed from the concave socket connects 16a and 16b and the handle can be removed from the grilling tool during the cooking process.

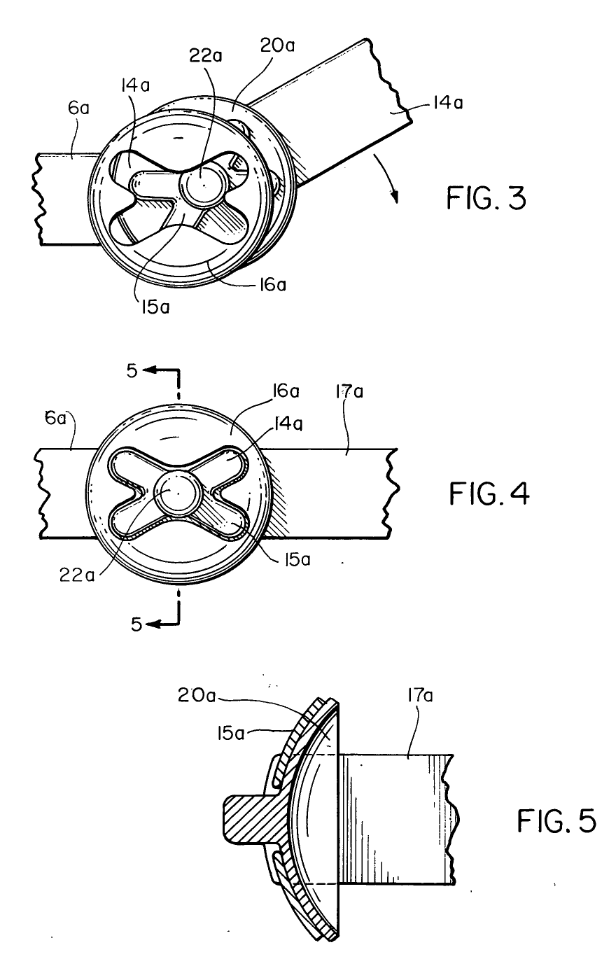

FIG. 3. shows an enlarged view of one of the convex ball connectors having a raised “X” pattern as fitted within the concave socket connector having a recessed “X” pattern. Each concave socket connector 16a and 16b has an aperture or recessed female pattern 16a on the interior surface of the concave socket connector, shown here as an “X” pattern. The female “X” pattern 14a is oriented in exactly the same position on each concave socket connector 16a and 16b. Thus, the female “X” pattern 14a is shaped to accept a raised or male “X” pattern 15a located on the exterior surface of the convex ball connectors 20a and 20b. The pattern is shown here as an “X”, the preferred embodiment, but can be of any shape and have similar results.

FIG. 4 shows one of the concave socket connectors 16a in the attached or locked in position by way of the raised “X” pattern 15a fitted into the recessed “X” pattern 14a. When in this attached or locked in position, the removable gripping handle 10 can be used to put the grilling tool 8 onto the grill, flip the grilling tool 8 over from a first side to a second side so the food can cook evenly on the coals. The removable gripping handle 10 can be removed from the grilling tool 8 during the cooking phase and then put back into the attached position so the grilling tool 8 can be removed from the grill.

FIG. 5 shows an enlarged side view of one of the convex ball connectors 20a. In the center of the male “X” pattern 15a is a leveraging nib 22a. The leveraging nib 22a is used for guiding the convex male pattern 15a into the corresponding recessed or female “X” pattern 14a of the concave socket connector 16a. The nib 22a is the first part to come into contact with the interior wall of the concave socket connector 16a. As the compressed pressure of the tong arms 17a and 17b is released, the nibs 22a and 22b slide down the concave interior walls of the concave socket connectors 16a and 16b to the center of the concave socket connectors and into the center of the recessed “X” patterns 15a and 15b. The nibs 22a and 22b hold the alignment needed until the positive and negative patterns are leveraged into position and locked into one another as shown in FIG. 4. The nibs 22a and 22b therefore allow the user to bring in the removable gripping handle 10 at any angle convenient to the user and slide the nibs 22a and 22b (as seen in FIG. 3) into the receiving finding or concave socket connectors 16a and 16b then lift the tool slightly off the grill or table top until the corresponding male and female patterns nest or seat themselves and thereby lock the gripping handle into position for use.

To those skilled in the art to which this invention relates, many changes in construction and widely differing embodiments and applications of the invention will make themselves known without departing from the spirit and scope of the invention. The disclosure and the description herein are purely illustrative and are not intended to be in any sense limiting.

What is claimed is:

1. A removable gripping handle for placing, lifting and moving grilling tools on a grilling surface, wherein said grilling tools have a fixed mounting bracket attached to a front side adapted to accept the removable gripping handle and said removable gripping handle comprising:
a generally U-shaped member having a pair of elongated tong arms connected together by an integral flexible portion at one end,
said elongated tong arms each having a convex ball connector at a bottom unconnected end;
said convex ball connectors having a raised pattern on an exterior surface adapted to fit within concave socket connectors having a corresponding recessed pattern on an interior surface;
wherein said concave socket connectors are fixed to the mounting bracket attached to the front side of the grilling tool.

2. The device as claimed in claim 1 further comprising “X’ patterns as the raised patterns in said convex ball connectors and “X” patterns as the recessed patterns in the concave socket connectors.

3. The device as claimed in claim 1 further comprising leveraging nibs on the exterior surface of and in the center of the convex ball connectors that serves as a guiding mechanism for locating the corresponding recessed patterns on the interior surface of the concave socket connectors by sliding down the interior surface of the concave socket connectors when the tong arms are compressed and then slowing releasing the pressure when the convex ball connectors are aligned within the concave socket connectors.

4. The device as claimed in claim 1 further comprising tong arms comprised of stiff metal material of uniform cross-section.

5. The device as claimed in claim 1 further comprising gripping members wrapped around and fixed to the elongated tong arms at a location between the integral flexible portion and the convex ball connectors.

6. A removable gripping handle for placing, lifting and moving grilling tools on a grilling surface, wherein said grilling tools have a fixed mounting bracket attached to a front side adapted to accept the removable gripping handle and said removable gripping handle comprising:
a generally U-shaped member having a pair of elongated tong arms connected together by an integral flexible portion at one end;
said elongated tong arms each having a convex ball connectors at a bottom unconnected end;
said convex ball connectors having a raised “X” pattern on an exterior surface adapted to fit within a concave socket connector having a corresponding recessed “X” pattern on an interior surface;
wherein said concave socket connectors are fixed to the mounting bracket attached to the front side of the grilling tool; and
leveraging nibs located on the exterior surface of and in the center of the convex ball connectors that is a guiding mechanism for locating the corresponding recessed “X” patterns of the concave socket connectors by sliding down the interior surface of the concave socket connectors when the tong arms are compressed and then slowly releasing the pressure when the convex ball connectors are aligned within the concave socket connectors.
